(19) United States
(12) Patent Application Publication
(10) Pub. No.: US 2018/0035689 A1
(43) Pub. Date: Feb. 8, 2018

(54) Method and Apparatus for Partitioning a Material

(71) Applicants: Benjamin P. Warner, Los Alamos, NM (US); Francesco de Rege Thesauro, Acton, NM (US)

(72) Inventors: Benjamin P. Warner, Los Alamos, NM (US); Francesco de Rege Thesauro, Acton, NM (US)

(21) Appl. No.: 15/641,255

(22) Filed: Jul. 4, 2017

Related U.S. Application Data
(60) Provisional application No. 62/371,574, filed on Aug. 5, 2016.

(51) Int. Cl. A23G 3/32; A23P 30/20

(52) U.S. Cl. CPC A23G 3/32; A23P 30/20; B33Y 10/00

(57) ABSTRACT

Methods and apparatus are described for the partitioning of difficult to handle materials such as viscous and sticky materials. The partitioning is accomplished accurately and precisely using an apparatus to extrude the material in portions on or in receptacles disposed on a stage.

### RELATED APPLICATIONS/CLAIM OF PRIORITY

This application claims any and all benefits as provided by law, including the benefit under 35 U.S.C. §119(e) of U.S. Provisional Application No. 62/371,574 filed Aug. 5, 2016 which is herein incorporated by reference in its entirety.

### FIELD OF THE DISCLOSURE

The present disclosure relates generally to partitioning of materials, for example the portioning of difficult to process viscous materials.

### BACKGROUND OF THE INVENTION

3-D printing is an additive manufacturing process that builds a part in a layer-by-layer fashion to create a three-dimensional object from a digital model. Initially developed in the mid 1980's and used subsequently in highly specialized industries with the expertise and financial means to mitigate the high costs, 3-D printing has recently become a technology that is cheap and accessible to almost anyone. Today's 3D printers include room sized systems but are more typically desktop instruments and can be used for creating and/or prototyping items as disparate as human organ replacements and turbine parts.

Although many materials can be used to make 3D printed parts, many materials are difficult or impossible to use as the print feedstock using the current technologies. There therefore is a need for 3D printers and methods of printing unconventional materials.

### SUMMARY

In general, methods, equipment and systems are described herein for the production of small portions accurately, precisely and repeatedly. For example, a viscous, sticky material or oily material can be partitioned into a plurality of non-contacting portions using an extruder equipped with a multi-zone heater or one-way valves.

In accordance with the invention there is provided a method for partitioning a material. The method includes extruding the material from a chamber through a CNC controlled nozzle and arraying the material onto a partitionable receptacle forming an array of non-contacting portions. The partitionable receptacle can include a surface for arraying the material upon with a surface energy below about 40 mN/m (e.g., a non-stick receptacle such as wax paper, perforated wax paper, and a TEFLON™ treated surface). The partitionable receptacle can also include a container (e.g., a capsule such as a medicinal, herbal or drug capsule, a vaporizing pen cartridge, a jar for a cream or for holding wax or oil). In some implementations of the method, the material is heated using a multi-zone heater having a first and a second zone. Optionally the difference in temperature between the first and second zone is at least about 5 degrees Celsius. The temperature difference between the first and second zone of the multi-zone heater can be less than about 80 degrees Celsius. Optionally, the temperature of the first and second zone is less than about 110 degrees Celsius (e.g., less than about 100 degrees Celsius, less than about 90 degrees Celsius, less than about 80 degrees Celsius). In another implementation, the method includes extruding material from the chamber through a one-way valve and through a nozzle, wherein the valve is disposed between an outlet to the chamber and the nozzle. Optionally, the method can further include filling the chamber with a material through an inlet and from a reservoir and through a one-way valve disposed between the reservoir and the inlet.

Optionally the partitionable receptacle comprises a coupon. (e.g., metal, plastic, paper, transdermal patch). The partitionable receptacle is a component of a transdermal patch. In some implementations of the method, the material can include a cannabis extract. For example, extracted using a solvent such as butane, supercritical carbon dioxide and ethanol. The cannabis extract can be selected from the group consisting of cannabigerolic acid (CBGA), cannabichromene acid (CBCA), cannabidiol acid (CBDA), Δ⁹-tetrahydrocannabinolic acid (THCA), cannabinol acid (CBNA), cannabigerol (CBG), cannabichromene (CBC), cannabidiol (CBD), Δ⁹-tetrahydrocannabinol (THC), cannabinol (CBN) and mixtures of these. In addition to or optionally, the material can include a terpene. For example, the terpene can be selected from the group consisting of Pinene (e.g., alpha-Pinene, Beta-Pinene), Myrcene, Limonene, Caryophyllene, Linalool, Terpinolene, Camphene, Phellandrene, Humulene, Phellandrene, Phytol, Pulegone, Bergamotene, Farnesene, Delta-3-Carene, Elemene, Fenchol, Aromadendrene, Bisabolene, alpha-Bisabolol, Borneol, Eucalyptol, Cineole and mixtures of these. Optionally the method includes a medicinal preparation that is consumed by ingestion, by inhalation, by smoking, sublingually or transdermally.

In some implementations of the method each non-contacting portion comprises between about 1 mg and 100 g (e.g., between about 1 mg and 1 g, between about 1 mg and 500 mg of material, between about 1 mg and about 200 mg, between about 10 mg and about 100 mg) of material. Optionally, the standard deviation of the average of the masses of the array of non-contacting portions is less than about 10% (e.g., less than about 5%, even less than about 1%). The method can be used as a batch process for the production of non-contacting portions of the material. Optionally, the batches include between 2 and 5000 portions (e.g., between 2 and 1000 portions, between 2-500 portions, between 2-100 portions). Optionally the portions are deposited at a rate of between about 1 mg/s and 1000 mg/s (e.g., 10 mg/s and 100 mg/s). In some implementations of the method, a second CNC controlled nozzle is used for arraying the material.

In some implementations of the method, the non-contacting portions are produced at an average rate of between about 0.002 and about 10 portions per second wherein the time is measured between the first portion that is extruded and the last portion that is extruded in a batch. For example, the average rate can be between 0.01 and about 1 portion per second. Optionally, the material is at a temperature between about 40 and about 100 degrees Celsius while being extruded (e.g., between about 40 and 80 degrees Celsius). The material can have a viscosity below about 1,000,000 centipoise (e.g., below about 10,000 centipoise) while being extruded. Optionally, the material can have a viscosity above about 10,000 centipoise while being extruded. Optionally, the material is made to contact and pass through, on and/or across a flexible applicator after being extruded and prior to being deposited onto the partitionable receptacle. For example, the flexible applicator is selected from the group consisting of a plastic nozzle, a silicone nozzle, a plastic tube and a silicone tube. Optionally the portions have an average width to average height ratio of greater than about two (e.g. between about 2 and about 100).

In accordance with the invention there is also provided a method of partitioning a material by extruding the material through a CNC controlled nozzle and arraying the material into at least two molds, forming an array of non-contacting portions.

The invention also includes a 3D printer for partitioning material. The 3D printer includes a chamber capable of containing the material and the chamber including at least one movable wall. The printer includes a mechanism for moving the wall that is CNC controlled. The printer also includes a multi-zone heater configured for heating the chamber and including at least a first and a second heater. The chamber includes an opening through which the material can be extruded to produce extruded material. The 3D printer also includes a stage for receiving the extruded material from the opening, wherein the relative positioning of the stage and opening is CNC controlled. In some implementations the first heater comprises an enclosure containing the chamber. Optionally the enclosure comprises at least a portion that is transparent.

In some implementations the chamber of the 3D printer is configured as a syringe, the movable wall is configured as a plunger coupled to the syringe and the first heater is configured to couple with the syringe barrel in a removable fashion. Optionally the first heater is configured to couple with the syringe in a removable fashion by utilizing an adaptor configured as a body having outer dimensions commensurate with the first heater and a hole through the body having a diameter equal to or larger than the syringe outer diameter. Optionally the adaptor includes a metal (e.g., aluminum, brass, copper or stainless steel). Optionally the syringe has a cylindrical barrel. Optionally, the force required to move the syringe in the direction of movement of the plunger is greater than the force required to move the syringe in a direction perpendicular to the direction of movement of the plunger. For example, the difference in force required to move the syringe in the direction of movement of the plunger and a direction perpendicular to the movement of the plunger can be at least 10 Newton (e.g., at least 15 Newton, at least 20 Newton, at least 30 Newton).

In some further implementations, the 3D printer further comprising a nozzle in fluid communication with the chamber and wherein the second heater is configured to couple with the nozzle (e.g., the nozzle and heater have complementary threading). Optionally, the first and second heater can provide a temperature difference of at least 5 degrees Celsius. In some implementations, the heaters can provide a temperature that is less than about 110 degrees Celsius (e.g., less than about 100 degrees Celsius, less than about 90 degrees Celsius, less than about 80 degrees Celsius). Optionally, the first and second heater can provide a difference in temperature of less than about 80 degrees Celsius. The first heater can include a flexible silicone heater and the second heater can include a cartridge heater.

In yet another implementation the 3D printer can further include an inlet to the chamber, a reservoir and a one-way valve disposed therebetween, wherein the one-way valve provides fluid communication between the chamber and reservoir with a direction of flow from the reservoir to the chamber. Further implementations of the 3D printer include a one-way valve disposed between chamber and the outlet, wherein the one-way valve provide fluid communication between the chamber and outside of the chamber with a direction of flow from the chamber to outside of the chamber. The valves can be CNC controlled and or controlled due to a difference in pressure across the valve.

In another optional implementation, the 3D printer further comprising a nozzle in fluid communication with the outlet and a first and second one-way valve, wherein the first one-way valve allows flow of material from the reservoir, through the outlet and through the nozzle, and the second one-way valve allows flow of material from a reservoir to the outlet and into the chamber. The valves can be CNC controlled and or controlled due to a difference in pressure across the valve.

The apparatus described herein can be used for partitioning materials that are liquids and viscous pastes. For example, the materials are useful for partitioning materials that are difficult to partition by hand such as resinous and stick materials that attach to implements such as spatulas. Also materials that at room temperature are brittle and hard can be hard to partition by hand and the apparatus described herein can be useful for these materials. The apparatus can also be used to prepare relatively small batch sizes, each apparatus preparing a small batch in one location (e.g., state, province) rather than large continuous processes that produce much larger amounts of materials in a centralized location (e.g., nationally, internationally). Such scale is useful for materials that are highly regulated such as medicinal materials. The scale of the apparatus makes this an economical as well as practical alternative. In addition, the apparatus as described herein has very little dead volume such as long inaccessible tubes wherein material is wasted and/or requires extensive cleaning. Rather, the material that is to be partitioned is efficiently utilized. The apparatus can also be useful for carefully controlling the temperature of the material while and just before it is being extruded, for example, so that the sample has a constant viscosity as it is extruded out of a nozzle. One way valves aid in flow control of difficult to partition materials from the extruder and into the extruder.

Other features and advantages of the invention will be apparent from the following drawings, detailed description, and from the claims.

### DESCRIPTION OF THE DRAWINGS

The foregoing will be apparent from the following more particular description of example embodiments of the invention, as illustrated in the accompanying drawings. The drawings are not necessarily to scale, emphasis instead being placed upon illustrating embodiments of the present invention.

FIG. 1 is a highly diagrammatic view of an apparatus for partitioning a material.

FIG. 2A shows a top down view of a partitionable receptacle. FIG. 2B shows a side view of the array of portions.

FIG. 3 shows a top down view of a partitionable receptacle with an array of material.

FIGS. 4A and 4B show top down views of arrays of differently shaped material

FIG. 5 is highly diagrammatic view of an apparatus for partitioning a material.

FIGS. 6A and 6B show an extruder.

FIG. 7 is a highly diagrammatic view of an alternative embodiment of an apparatus for partitioning material.

FIG. 8A shows a blown up perspective view of a heater and a holder assembly.

FIG. 8B shows a perspective view of a heater and holder.

FIG. 9A shows a blown up perspective view of the chamber configured as a heated syringe.

FIG. 9B shows a perspective view of the chamber configured as a heated syringe.

FIG. 10A shows a blown up perspective view of a heated syringe with a cover.

FIG. 10B shows a perspective view of a heated syringe with a cover.

FIG. 11A shows a perspective view of an adaptor for a syringe extruder and its combinations with an extruder.

FIG. 11B shows a perspective view of a heated syringe extruder including an adaptor.

FIG. 12 is a top down cross cut view of a heater/holder assembly and adaptor for an extruder.

FIG. 13 shows a side view of a heater/holder assembly and syringe extruder mounted on a 3D printer Z-axis linear actuator.

FIG. 14 shows an embodiment of an apparatus for partitioning material including an extruder and one-way valves.

FIG. 15 shows another embodiment for partitioning material including an extruder and one-way valves.

FIG. 16 is a plot of mass to deposited portion for a first test.

FIG. 17 is a plot of mass to deposited portion for a second test.

### DETAILED DESCRIPTION

### Glossary

As used herein, CNC control refers to computer numerical control. For example where the motions of a machine are controlled by a prepared program containing coded alphanumeric data such as G-code. CNC control can control the motion of a nozzle and stage of an additive manufacturing machine relative to each other (e.g., their relative x, y, and z position), other energy outputs (e.g., heating, cooling, and electrical power to a laser), weight on a printer bed, optical feeds from digital cameras and speed of extrusion of a feedstock.

As used herein, a linear actuator refers to an actuator that creates motion in a straight linear path.

As used herein; x, y and z (lower case) are Cartesian coordinate points. X, Y and Z (Upper case) refer to the Cartesian directions and Rₓ, R_{y} and R_{z} are rotational directions about the subscripted axis. Clearly, other coordinate systems can be used by applying the appropriate transfer function, e.g., to polar coordinates.

As used herein, viscosity is a measure of a liquid's resistance to deformation by shear or tensile stress. Low viscosity liquids have a viscosity of less than about 10,000 centipoise and can be poured (e.g., up to about the consistency of honey at room temperature). Medium viscosity liquids have a viscosity between about 10,000 centipoise and about 1,000,000 centipoise (e.g., pastes including ketchup and peanut butter) and can be extruded with moderate force but cannot be easily poured. High viscosity liquids have viscosity above about 1,000,000 centipoise and are pastes or putties that cannot be poured (e.g., Caulking compounds between about 2 and 5 million cP, window putty more than 100 million cP).

As used herein “disposable” means that a component is meant to be replaced more often than most components of the system in which it operates. For example, a syringe that is disposable can be filled and emptied a few times (e.g., less than 100, less than 50, less than 10) before it should be discarded due to it not working optimally (e.g., it becomes contaminated or it might stick or components might swell or otherwise be damaged or susceptible to damage such as rupture).

### EMBODIMENTS

Using the equipment, methods and systems described herein, and illustrated in the figures, a difficult to partition material can be partitioned. For example, apparatus and methods are described for partitioning of viscous and sticky materials such as resins and oils.

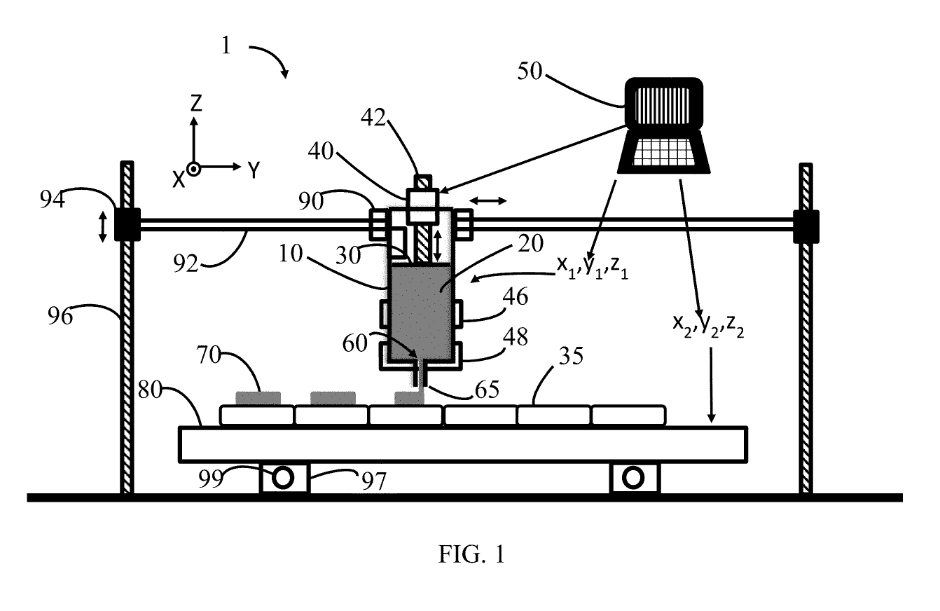

FIG. 1 is a highly diagrammatic view of an apparatus 1 for partitioning a material. The apparatus includes a chamber 10 capable of containing a material 20. The chamber includes at least one movable wall 30. The wall can be made to move by a mechanical device 40 (e.g., a stepper motor) coupled to a screw 42 and nut (e.g., components of a linear actuator) in mechanical communication with the wall. For example, the wall can be made to move up and down in the Z direction as indicated by the double headed arrow next to screw 42. The device 40 can be controlled by a CNC controlling device 50 such as a computer executing an algorithm, and using an appropriate intermediate hardware (e.g., an Arduino motherboard). The chamber 10 also includes at least one opening 60 through which material 20 can be extruded. A nozzle 65 can be attached to the opening and provide fluid path from inside the chamber to outside of the chamber. The material 20 can be extruded out of chamber 10 through the opening and deposited as extruded material 70 (e.g., having the same composition as 20). A stage 80 is disposed to receive the extruded material from the nozzle. The stage can be heated (e.g., up to about 120 degrees Celsius) and/or cooled (e.g., down to about −40 degrees Celsius). The stage can include a partitionable receptacle 35 that is placed on the stage and disposed between the stage and nozzle so that material is extruded onto the partitionable receptacle (e.g., a first layer of extruded material is deposited on the receptacle 35 with subsequent layers deposited on previously deposited material). The relative position of the stage 80 and the opening 60/nozzle 65 is controlled by the CNC control, therefore the relative position of the partitionable receptacle 35 and the nozzle is also controlled by the CNC control. The nozzle can include a valve to help control the flow of material. The valve can be pressure controlled, for example, the valve can be configured to open when wall 30 compresses material 20 and the valve closes when the wall 30 retracts. The valve can also be CNC controlled, for example the valve can be set to open when the wall 30 moves in a direction to compress material 20 and the valve can be set to close when the wall 30 is not moving.

A multi-zone temperature controlling apparatus can be used to heat or cool the chamber and/or nozzle. For example a multi-zone temperature control apparatus with zones 46 and 48 can be included with apparatus 1. In this embodiment zone 48 is closer to the opening 60 than zone 46. The multi-zone temperature control apparatus can include two or more zones (e.g., three, four, five or more zones arranged along the length or Z direction of the chamber 10). The temperatures of each zone can be independently set to any desired temperatures. For example, any temperatures between about −50 and 400 degrees Celsius, with control in each zone of about +/−0.1 degrees Celsius. The temperature control apparatus can be configured with heaters and/or coolers. For example, the heaters can be heating tape that contacts the chamber, a conducting metal in contact with the chamber and a heating cartridge, a hot air gun directed at the chamber, an IR lamp directed at the chamber, a heating jacket with a heating fluid passing therethrough (e.g., heated water, heated oil, heated air), a resistive heater embedded in a flexible rubber (e.g., a flexible silicone rubber insulated heater), or any radiative heater in proximity to the chamber. The entire chamber can be heated or a portion of the chamber can be heated. In some embodiments the heater directs heat near the outlet of the chamber such as at a nozzle attached to the chamber. In some embodiments the chamber includes an insulated portion distal from the opening and a heat conductive portion proximal to the opening. The heaters can provide temperatures between ambient temperature and about 400 degrees Celsius (e.g., less than about 110 degrees Celsius). Coolers can be a fan, a radiator and/or a cooling jacket with a cooling fluid passing therethrough (e.g., cooling water, chilled air and chilled gas such as nitrogen). The heating and/or cooling of the zones is controlled by the CNC control. The temperature is monitored, for example by a thermistor or thermocouple integrated with each of the zones or in the chamber proximate to the heating zone, an IR heat detector directed at the chamber and/or nozzle or any other useful heat monitoring device (e.g., a thermometer).

The CNC control communicates with electrical and mechanical devices that control the relative position of the chamber 10 (e.g., x₁, y₁, z₁) and of the stage 80 (e.g., x₂, y₂, z₂). In addition, the CNC control communicates with the mechanism 40 and thus the extrusion rate out of opening 60 and nozzle 65. For example, extrusion rates can be controlled between about 1 mg/s and about 1000 mg/s for a nozzle aperture size of about 2 mm (e.g., between about 0.2 mm and about 3 mm). Larger systems with larger nozzles can extrude material at a faster rate. The CNC control also controls the temperature of the multi-zone temperature control apparatus as previously described. For example, the CNC controls stepper motors coupled to the stage or chamber through direct screw drives, belts and or pulleys. Gantries, tracks and other methods of smooth movement of the stage and/or chamber relative to each other in X, Y and Z directions can be used. In an embodiment, an algorithm executes a relative X and Y movement of the opening/nozzle to the stage while extruding material at a specified rate, optionally followed by an incremental movement up in the Z direction, and deposition of another layer by relative movement in the X and Y directions. The algorithm may include pauses in motion, and motions in any direction. Such motions can be used to allow inspection, adjustment, modification, or other actions to be performed on the material being extruded or the apparatus. It is understood that the relative movement of the chamber and stage can be achieved by many different configurations. For example, under CNC control and the electrical and mechanical devices, the stage may move in the X and Y direction and the chamber moves in a Z direction; in another configuration the stage may move in a Z direction and the chamber moves in an X and Z direction; alternatively the stage may move in a Y direction while the chamber moves in an X and Z direction; in another option the stage may not move and the chamber may move in X, Y and Z directions. The exact configuration for CNC movement can be selected by the Artisan. In some embodiments such as depicted in FIG. 1, the chamber can be relatively heavy since it supports all of the feed material and linear actuator. Therefore, it may require a strong rigid structure made of metal (e.g., aluminum and/or steel).

FIG. 1 shows one possible configuration for movement using a gantry to move the chamber relative to the stage. The gantry has a carriage 90 that is fastened to the chamber. The carriage can move in the Y direction on rail 92. The rail is fastened to nut 94 which is coupled to screw 96 and therefore can move the chamber in the Z direction. Movement of the carriage and screw can be done using stepper motors coupled to the carriage and screw (e.g., direct drive for the screw, through a belt for the carriage). The stage can be moved in the X direction with a second carriage 97 and rail 99. Other configurations include a stage that does not move and a gantry with 3 orthogonal rails to move the chamber in X, Y and Z directions are conceived.

As previously described, the movable wall 30 can be moved by means of a linear actuator that is in mechanical communication and/or contact with the wall. For example, as shown in FIG. 1, the actuator is in contact on one side of the wall while the other side is in contract with the material. Although a screw and nut is depicted in FIG. 1, any suitable linear actuator can be utilized. In some embodiments, the linear actuator can be selected from the group consisting of a screw and nut, a pneumatic or hydraulic piston, a solenoid, a wheel and axle or a cam. For example, by rotation of an actuator nut relative to a screw, the screw can move in and out of the threaded hole in a linear fashion (e.g., or the nut moves up or down the shaft). In an alternative, a wheel and axle can be coupled to a belt that is also connected to a rigid shaft and can move the shaft in a linear fashion. Also, a cam can be used to provide thrust at the base of a shaft.

Mechanisms other than a linear actuator are recognized for moving the walls of the chamber. For example, the Tube-Wringer® (Gill Mechanical Co., Oregon) acts by squeezing two walls of a flexible tube (e.g., configured as a toothpaste or caulking tube) between rollers. Such rollers could be modified to be driven by a motor and CNC controlled. Alternatively, more than one linear actuator could be used, for example, pushing on two walls of the chamber, such as opposing sides of a flexible tube.

The equipment, methods and apparatus herein can have very little dead volume. That is, at least 90 vol. % (e.g., at least 95 vol. %, at least 99 vol. %) of the contents (e.g., 20 in FIG. 1) in the chamber (e.g., 10) can be extruded out through the nozzle.

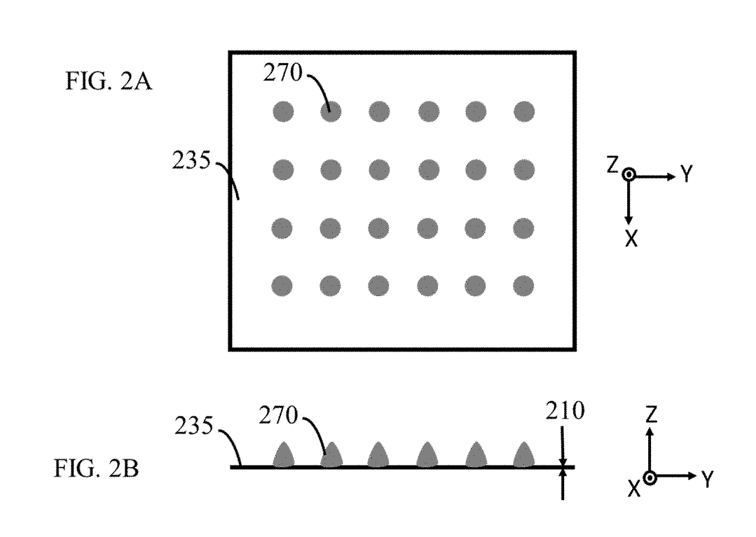

FIG. 2A shows a top down view of a partitionable receptacle 235 with material 270 deposited as an array of portions. FIG. 2B shows a side view of the array of portions. The partitionable receptacle can be a thin sheet such as a sheet of metal foil (e.g., aluminum foil), plastic (e.g., cellophane), paper (e.g., wax paper) or a foodstuff (e.g., a crepe.). For example the sheet can of a thickness 210 between about 0.1 mm and about 5 mm. In some embodiments, the sheet is easy to partition by hand, for example, by tearing or cutting with a blade (e.g., scissors, Guillotine cutters, rolling cutter).

In some embodiments, the receptacle is a non-stick receptacle such that it has at least one surface having a low energy disposed for receiving the depositing material. For example, the low energy surface can have a surface energy below about 40 mN/m e.g., between about 20 mN/m and about 40 mN/m or between about 25 mN/m and 28 mN/m. Without being bound to a specific mechanism, it is believed that having a too high surface energy will make separation of the deposited material from the surface difficult. Alternatively, having a surface energy that is too low can make it difficult to allow the material to stick to the surface sufficiently to, for example, print or deposit a material (e.g., the material may travel with the nozzle as it moves relative to the surface).

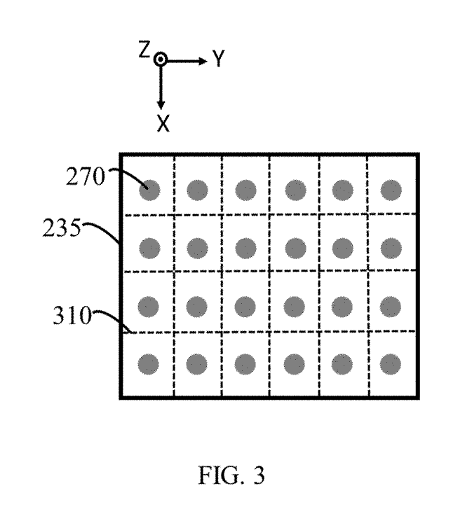

FIG. 3 shows a top down view of a partitionable receptacle with an array of portions. The partitionable surface is a sheet that has been perforated wherein the perforations are shown as dashed lines 310. The perforations can facilitate the portioning of the receptacle as well as help organize the array of deposited material. Other methods are envisioned that can serve this purpose, such as lines drawn on the receptacle (e.g., etched, painted or drawn) and/or methods of weakening the receptacle (e.g., to facilitate it's partitioning) such as etching and scouring.

The material can be deposited as a regular array of material as shown above. For example, FIGS. 2A and 3 show 4 rows by 6 columns of portions, or 24 partitions of the material 270. The 24 partitions can be considered a batch and after a batch of material has been extruded, the partitionable receptacle is removed and a new partitionable receptacle can be supplied to the machine so that additional batches can be made. Batches can include one or more partitions and depend in part on the size of each partition as well as the size of the partitionable receptacle. The partitioning is precise and accurate and the amount of material in each portion is determined by the operator through use of the CNC control. For example, materials can be partitioned into portions of greater than about 1 mg (e.g., greater than 10 mg, greater than 50 mg) and as large as the volume of the apparatus allows (e.g., 1 Kg). Accuracies of greater than +/−10 mg (e.g., greater than +/−5 mg, greater than +/−1 mg) are readily achieved. In some embodiments the individual portions weigh between about 10 mg and about 100 g (e.g., between about 1 mg and about 50 g, between about 1 mg and about 10 g, between about 1 mg and 1 g, between about 1 mg and 500 mg of material, between about 1 mg and about 200 mg, between about 10 and about 100 mg). Also, in some embodiments the batches include between 2 and 5000 portions (e.g., between 2 and 1000 portions, between 2-500 portions, between 2-100 portions).

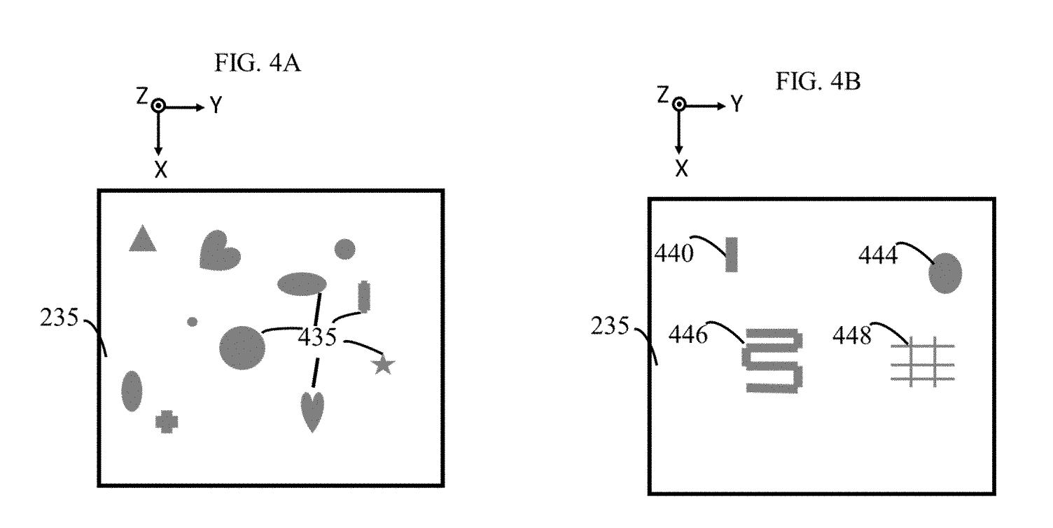

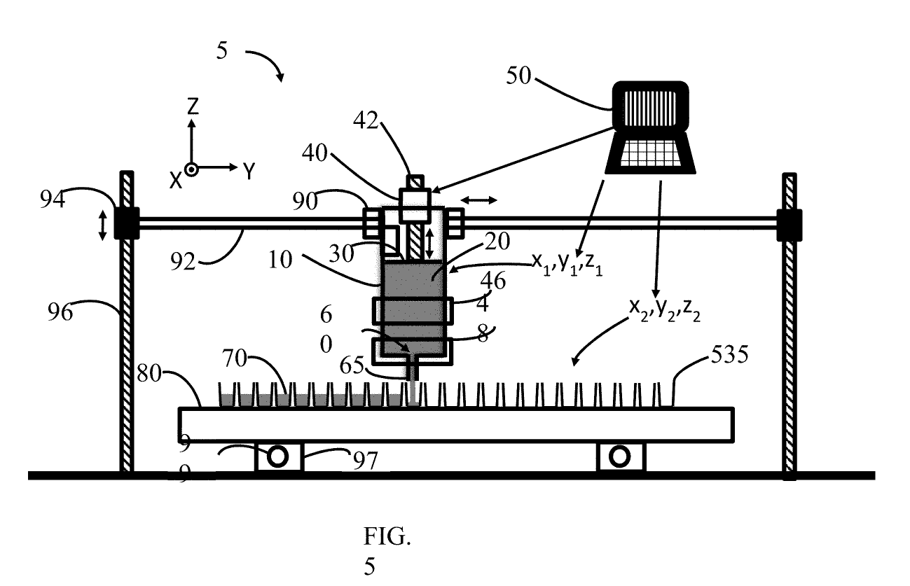

Although the embodiments show a regular array of deposited material, the material can be deposited in an irregular array as determined by the operator and/or designer of the run and implemented by the CNC control of the apparatus. In addition, the embodiments show deposition of material with similar shapes. It is envisioned that the material can be deposited in arrays of different shapes. For example, FIG. 4A shows a top down view of an irregular array of differently shaped material 435 deposited on a partitionable receptacle 235. For example the material can be deposited as designs of people, faces, animals, trees, flowers, leaves, logos, mosaic or other artistic designs.

In some embodiment only a single layer of material is extruded per non-contacting portion. The portions can also have a high width to height aspect ratio. For example, as shown in FIG. 4B (top down view) material can be deposited as long flat strips 440 such as sub-lingual strips or gum strips, medallions 444, serpentine shapes 446, and even lattices 448. The portions, such as those shown in FIG. 4B, can have an width to height ratio of greater than about 2 and optionally greater than about 5 (e.g., greater than about 10); wherein the width is measured as the diameter of a circle drawn parallel to the XY plane that contains the non-contacting portion such as 440, 444, 446 or 448, and the height is the maximum distance perpendicular to the circle containing the non-contacting portion.

FIG. 5 is a highly diagrammatic view of an apparatus 5 for partitioning a material. The partitionable receptacle is configured as a plurality of containers 535. The stage 80 can provide a flat surface for placement of the containers, or the stage can be configured with fixtures for placing and/or holding the containers in specific locations. For example, the fixture can include indentations or holes that the containers fit in. Guiding lines can also be scribed, etched or drawn on the stage to indicate where containers should be placed. Guiding lines can also be scribed, etched or drawn on a jig or tray placed on the stage to indicate where containers should be placed. Containers that can be used in the apparatus include cartridges (e.g., vaporizing pen cartridges), capsules (e.g., medicinal and herbal capsules), and bottles (e.g., 0.5 mL to 100 mL bottles).

Other embodiments include the partitionable receptacle configured as a portion of a transdermal patch. For example, the partitionable receptacle can be a release liner, the backing layer or a rate controlling membrane. Alternative embodiments include the partitionable surface configured as metal (e.g., titanium) and ceramic (e.g., glass, quartz) coupons or containers where upon the material is deposited in non-contacting portions.

It is understood by the artisan that a non-contacting portion might have a small amount of contact. For example, some materials can form thin strands that bridge two or more of the non-contacting portions. This can occurs with very viscous and sticky materials such as resins and gums. In these cases the amount of material in such contacting strings are less than about 1 wt. % of the material in the non-contacting portion.

Although control of the portion amounts can be controlled by flow rates, a feedback mechanism including an automated system for weighting the portions or optically observing the portions while they are extruded is envisioned. For example, a single or an array of piezoelectric devices placed under the partitionable receptacle and on the stage that detect the weight of material as it is extruded. The signal from the piezoelectric devices can be fed back to the CNC control which modulates an extruding mechanism such as 40. Similarly, optical detection of the extruded amount can be implemented by a digital camera and the images compared to expected profiles. For example, if the partitionable receptacle is configured as a container, the level of filling can be detected optically. Alternatively, the weighing and/or optical device can be passive and it can record the amount of material deposited as the operation proceeds. The record can then be inspected to determine if the deposition process was within acceptable parameters. Portions that are not within acceptable limits can be discarded or recycled.

In some embodiments, the chamber and movable wall are configured as a syringe, with the barrel of the syringe defining the chamber and the movable wall being the surface of the plunger placed inside the barrel. In optional embodiments the syringe is partially or completely disposable. For example, the syringe can include a lining, tube or a cartridge that is disposable.

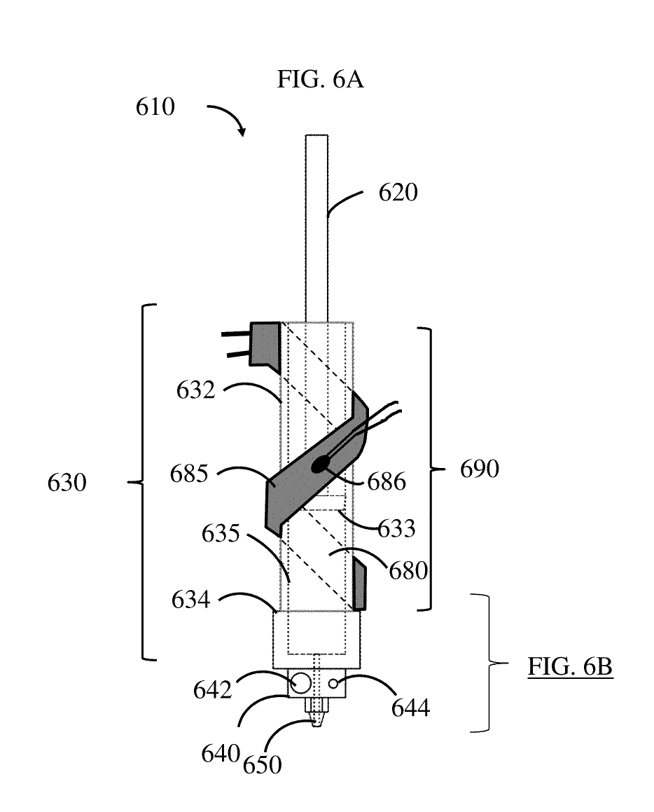

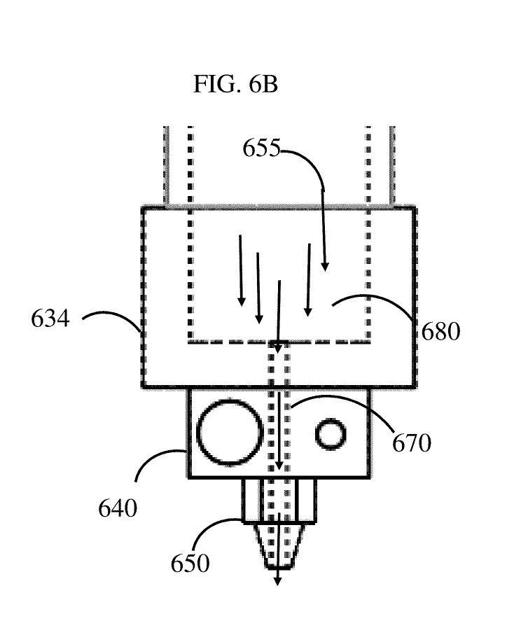

An embodiment of the chamber configured as a heated syringe 610 is shown in FIG. 6A as a cross cut view. The plunger 620 fits in the barrel 630. The plunger surface 633 and internal surfaces of barrel 635 defines the chamber 680 that can contain a material to be extruded. The barrel can include a portion that is made of an insulating material 632 (e.g., a plastic, silicon glass, ceramic) and a heat conductive material 634 (e.g., a metal such as aluminum or stainless steel); alternatively the barrel may be entirely made of a conducting material or an insulating material. A heating block 640 is attached to the heat conductive material. The heating block includes a cartridge or a resistive heater 642 and can include a thermistor 644. Wires to the heating cartridge and thermistor are not shown. In some embodiments, the heating block is made of a heat conducting material. A nozzle 650 is attached to the heating block. For example the nozzle and heating block can include complementary threading so that the nozzle can be screwed into the heating block. The nozzle can be made of a heat conducting material or an insulator. FIG. 6B shows a magnified view of the extruding end of the heated syringe. A channel 670 passes through 634, 640 and 650. Therefore, the contents of the chamber 680 are in fluid communication through the heating block and nozzle through channel 670 and material can be made to extrude from the chamber, through the heating block and through the nozzle as indicated by the arrows 655 in FIG. 6B.

Is some embodiments, the chamber portion 632 (FIG. 6A) is disposable. The chamber portion 632 can be removably connected to chamber portion 634, for example such that 632 fits into 634 and the two are complementarily threaded and/or held together by friction and/or fasteners. Therefore, once material has been extruded from the chamber, 632 can be removed (e.g., by unscrewing from 643) and a new chamber portion 632 that is charged (e.g., full of the desired extruding material) can be attached to the 634 and extrusion can then be resumed. Heating tape 685 can be wrapped around the barrel 632 and thermistor 686 can be placed on the heating tape or between the heating tape and the outer surface of 632 so that the temperature of zone 690 can be controlled.

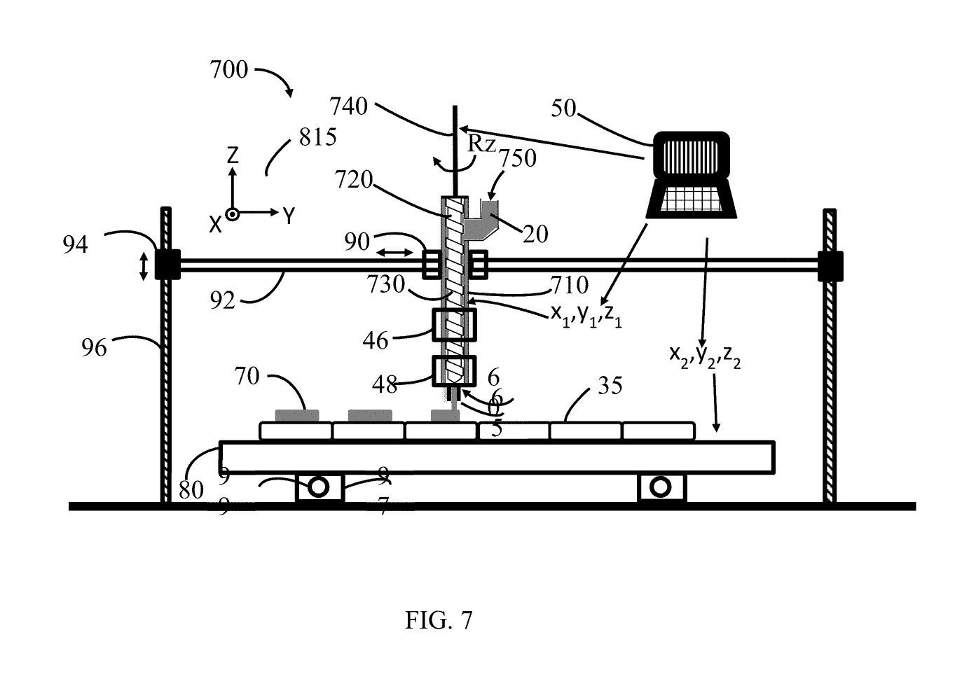

FIG. 7 exemplifies another embodiment of an apparatus 700 for portioning material wherein the movable wall can be the screw of an extruder. For example the screw extruder (shown as a cross cut view) has a chamber 710, containing the screw 720. The flights of the screw make a moving wall 730 in the chamber. A mechanism for moving the screw (e.g., the wall) can be a rotatable shaft 740 e.g., rotating in the direction indicated by curved arrow R_{z}. A drive motor can be coupled to the shaft to have it rotate around its axis (the drive motor is not shown). The rotation speed can be controlled by the CNC controller 50. The extruder can be continuously fed through an extruder ingress 750, for example where the ingress is coupled to a feed-hopper. Other features are the similar as indicated in FIG. 1; Material 20 in the chamber 710, extruded material 70, opening 60, nozzle 65, stage 80. In the embodiment shown, gantry with carriage 90, rail 92, nut 94, screw 96, rail 99 for the stage and carriage 97 for the stage is shown as previously described. Multi-zone temperature control apparatus with zones 46 and 48 can also be included.

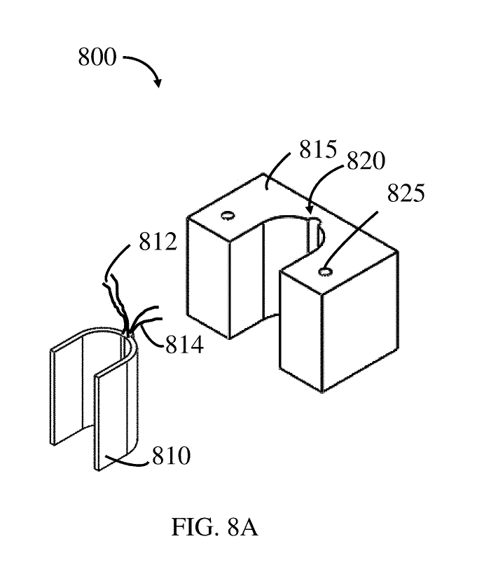

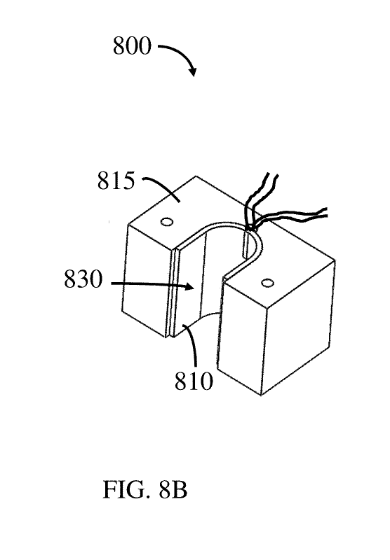

FIG. 8A shows a blown up perspective view of a heater and a holder assembly 800. FIG. 8B shows a non-blown up view of the heater and holder. The heater 810 is a flexible or rigid heater that is configured to fit into the rigid holder 815. A thermistor (not shown) is affixed to the heater and is accommodated in the holder by an indentation 820. Wires for the heater 812 and the thermistor 814 are shown. The heater can be a flexible silicone insulated heater, a metal encasing a cartridge heater and/or a ceramic encasing a resistive heater. An adhesive can be applied to the heater and/or the holder so that the adjoining surfaces are fixed in place. Other attachment methods to fix the heater and holder together such as screw fasteners and complementary slots/ridges can be used. The holder can be made of any rigid material. In some embodiments the holder is an insulator such as a plastic, rubber and/or ceramic material. Holes 825 can be machined or created in the holder for fixing to a 3D printer. Other methods for fixing the holder to the printer can be used.

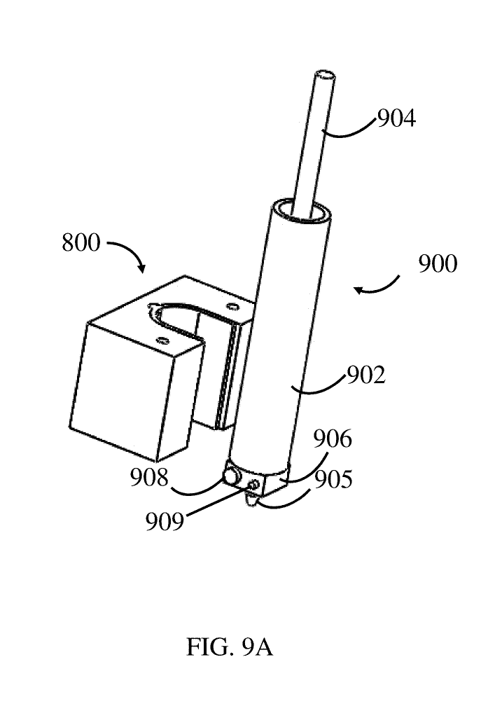

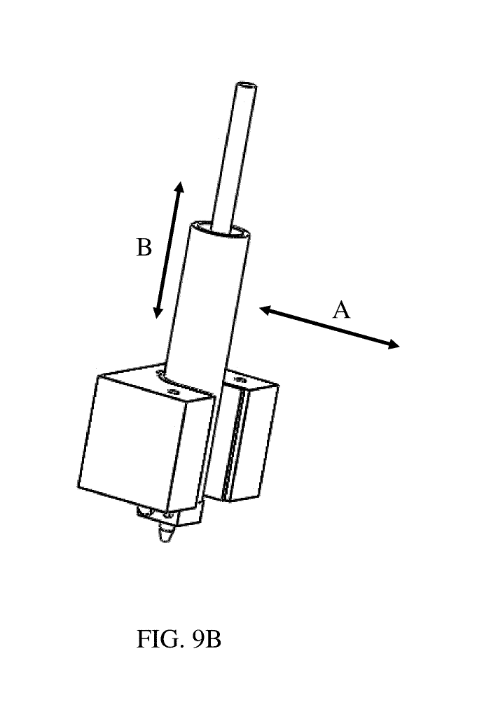

FIG. 9A shows a blown up perspective view of the chamber configured as a heated syringe 900 in combination with the heater/holder assembly 800. FIG. 9B shows the same in a non-blown up view. The heated syringe comprises a barrel 902, a plunger 904, a nozzle 905, and a heating block 906. The heating block includes a heating cartridge 908 and thermistor 909 embedded therein. Wires to the heating block cartridge and thermistor are not shown in the figure. The heating block is optionally made of a heat conducting material. A nozzle 905 is attached to the heating block. For example the nozzle and heating block can include complementary threading so that the nozzle can be screwed into the heating block. The nozzle can be made of a heat conducting material or an insulator. The nozzle provides a channel for the contents in the chamber (e.g., the syringe) to flow through as described previously in FIG. 6B.

In addition to heating, the assembly 800 can provides a support to the heated syringe 900. For example, the assembly 800 and syringe 900 are dimensioned such that the syringe is easy to remove by hand (FIG. 9B) by pulling in the direction indicated by arrow A (e.g. a direction perpendicular to the plunger movement) yet does not move while force is applied in the direction of the arrow B (e.g., the direction of the plunger movement). The assembly can therefore have enough flexibility to expand to accept the barrel 905 while once in place, the barrel is held tightly. For example, in some embodiments, a heater made with a flexible material such as silicone or with a surface that contacts the syringe that includes a flexible material can be used.

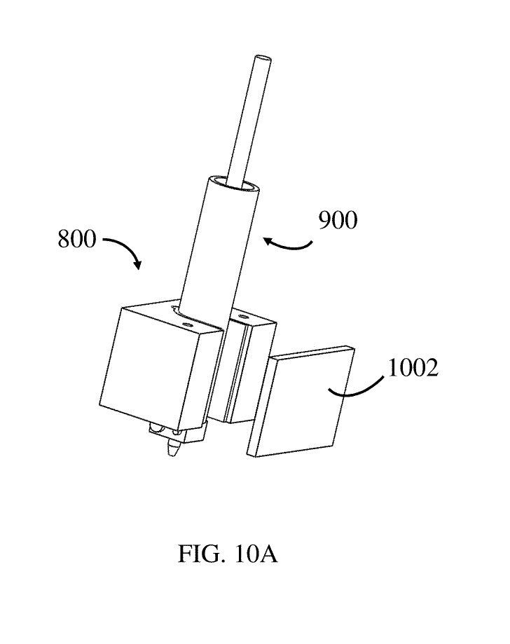

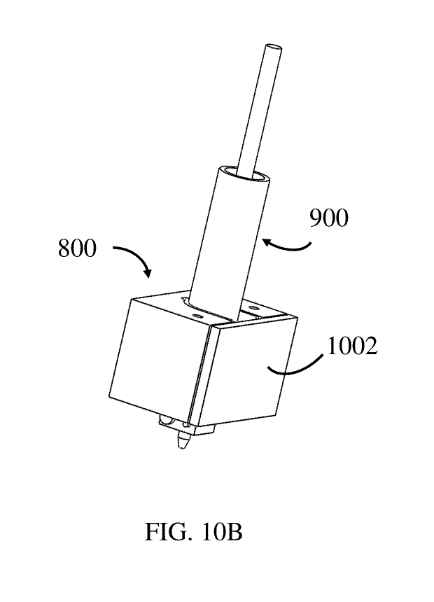

A cover can be used as shown in FIG. 10A in an exploded view and FIG. 10B in a non-exploded view. The cover 1002 is optionally an insulator and can be transparent. For example, using a transparent cover and transparent syringe can be advantages to monitor the contents of the syringe. The cover can be attached to the assembly 800 by any useful means (not shown in the figures). For example, magnetic fasteners, hook and loop, hinges, latches, bolts and nuts, screws, elastic materials, slots in the assembly 800 or combinations of these. The cover can present a curved or partially curved surface to match the curvature of the syringe barrel. The cover can also include a heating element, such as a silicone heater or an aluminum encased heater. In some embodiments the assembly 800 and cover allow air to circulate around the chamber (e.g., and extruder syringe) and the air can be heated or chilled providing cooling or heating (e.g., such as in an oven). The cover and heater assembly form an insulating enclosure for at least a portion of the extruder chamber, e.g., a heating zone.

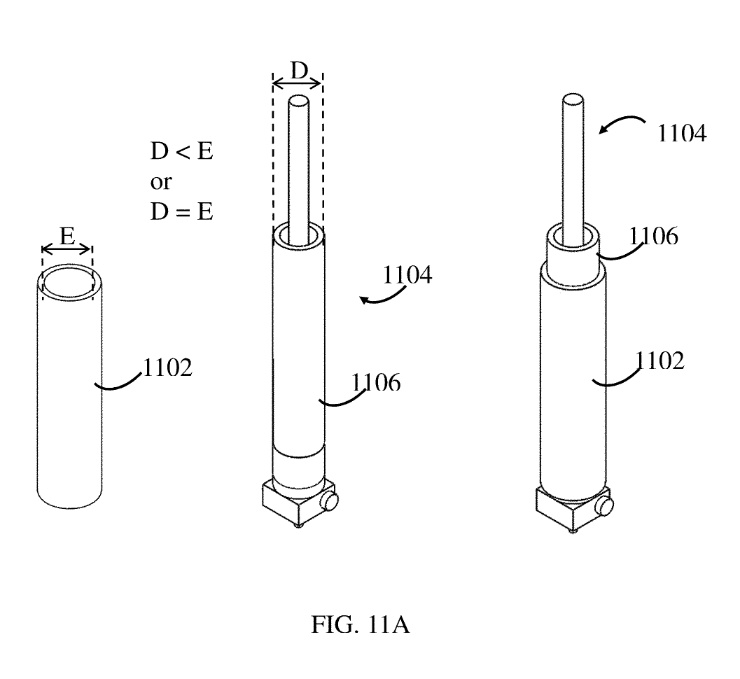

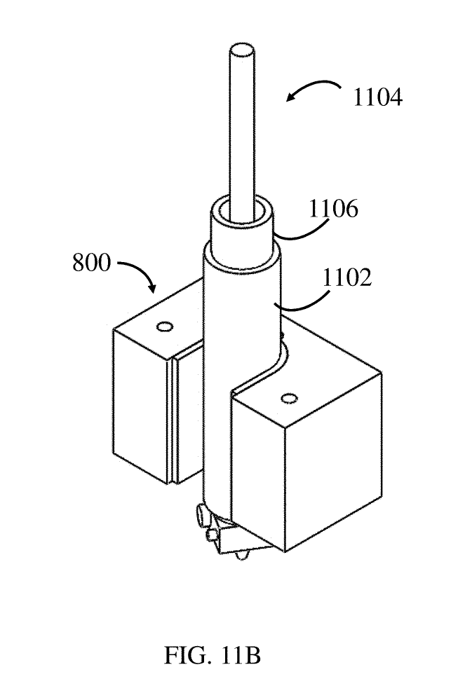

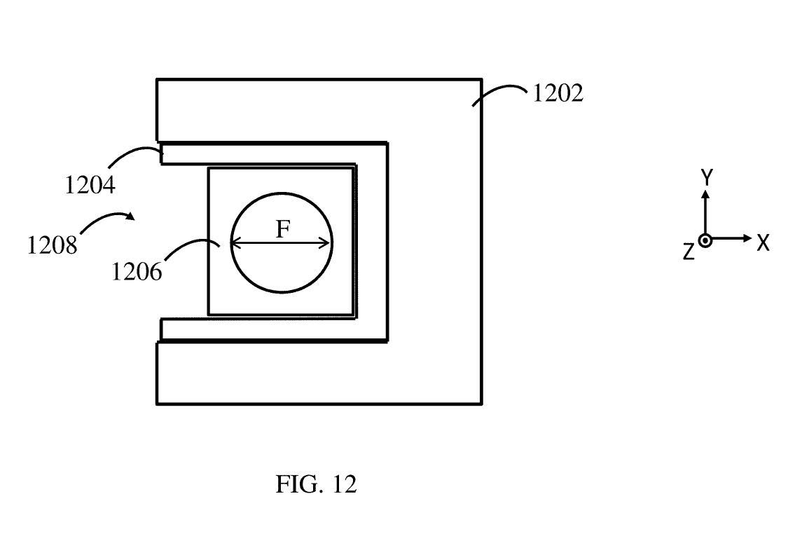

The assembly 800 can be configured to accommodate any size syringe. In addition, an adaptor can be made of a heat conductive material such as a metal (e.g., aluminum, brass, copper and/or stainless steel) so that syringes of different sizes can be used with the assembly 800 and heat can be transferred efficiently from the heater, through the adaptor to the syringe extruder. For example, the adaptor can be a hollow tube 1102 as shown in a perspective view in FIG. 11A. A syringe extruder assembly 1104, having a barrel 1106 with an outer diameter D equal to or a little smaller than the inner diameter E fits into the adaptor as shown. For example the difference between D and E can be less than about 5 mm (e.g., less than about 1 mm, less than about 0.5 mm, less than about 0.1 mm). The adaptor can be held in place by friction between the contacting surfaces of the adaptor and syringe barrel and or by fasteners or any other means such as a support at the bottom of the syringe that does not allow the adaptor to slide down the barrel. The assembled syringe and adaptor can then be combined with the assembly 800 where the slot size of 830 and the outer diameter of the adaptor are commensurate as shown in FIG. 11B.

Another embodiment for the configuration of the heater/holder assembly 800 that can couple with a syringe extruder 1104 and an adaptor is shown in FIG. 12. For example, the heater/holder assembly can have a rectangular slot as shown as a top down cross cut view in FIG. 12. The holder 1202 is commensurate in shape with the heater 1204, which is commensurate in shape with the adaptor 1206 outer dimensions and the adaptor optionally has a cylindrical hole of diameter F which is larger than or equal to the outer diameter of a syringe extruder that can fit therein.

Other configurations of heater holder, heater and extruder chamber are envisioned For example, the syringe extruder can have an outer surface and geometry that is a cuboid wherein the adaptor hole could be square or the syringe extruder could fit in the slot 1208 provided by holder 1202 and heater 1204 assembly.

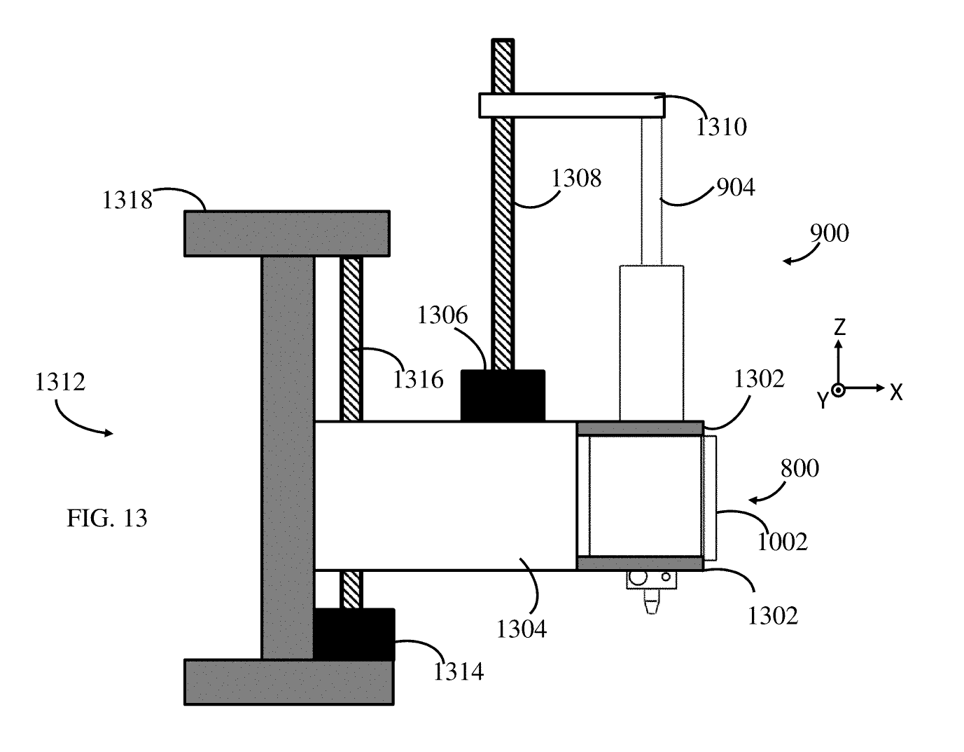

FIG. 13 shows a side view of how the heater/holder assembly 800 can be mounted on a 3D printer for partitioning a material. The assembly 800 can be fastened to holders 1302 using a bolt passed through holes 825 (see FIG. 8A). Holders 1302 are attached to structure 1304 which is attached to motor 1306. Motor 1306 is coupled to plunger 904 through screw 1308 and holder 1310. CNC control of the motor allows control of the movement of the plunger. The structure 1304 is coupled to linear actuator 1312 comprising motor 1314 screw 1316 and holder 1318. Therefore, linear actuator 1312 provides CNC controlled movement of the syringe in the Z direction independent of the plunger movement. The Linear actuator can be coupled to XY control as previously described. Other support structures can be added by the Artisan.

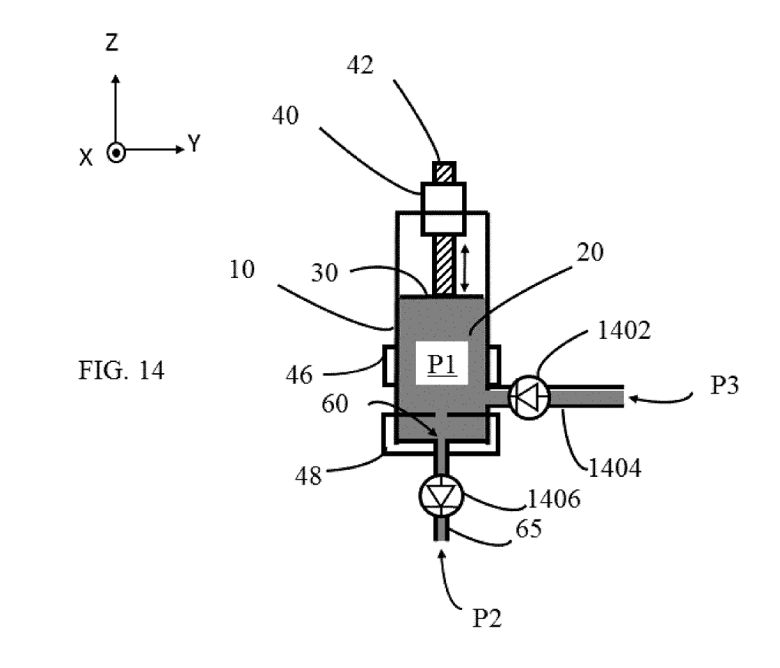

FIG. 14 shows another embodiment of an apparatus for partitioning materials including an extruder with two one-way valves. The one-way valve 1402 allows material 20 to flow from a reservoir (e.g., a container, bottle, hopper) attached to inlet 1404 into chamber 10 when wall 30 moves in the positive Z direction. The valve 1402 closes when the wall 30 moves in the negative Z direction (e.g., compressing the material 20). The one-way valve 1406 opens and allows material 10 to flow out of chamber 10 and through nozzle 65 when wall 30 moves in the negative Z direction (e.g., compressing the material 20). The Valve 1406 closes when wall 30 moves in the positive Z direction. The valves can be actuated by CNC control directly, for example such that the valves are closed when wall 30 is not moved in the Z direction and are open or closed as described above depending on the movement of wall 30. Alternatively, the valves can be actuated by a change in pressure across the one-way valves. For example, when the pressure P1 inside the chamber 10 is greater than the pressure P2 at nozzle 65, material 20 flows out of the chamber through nozzle 65. When pressure P2 is greater than pressure P1 material does not substantially flow through valve 1406. When pressure P3 at the inlet 1404 is higher than the pressure P1 inside chamber 10 material 20 can flow through the valve 1402 into chamber 10, while when pressure P3 is less than P1 material does not substantially flow through valve 1404. The extruder forms a component of an apparatus for partitioning a material as previously described.

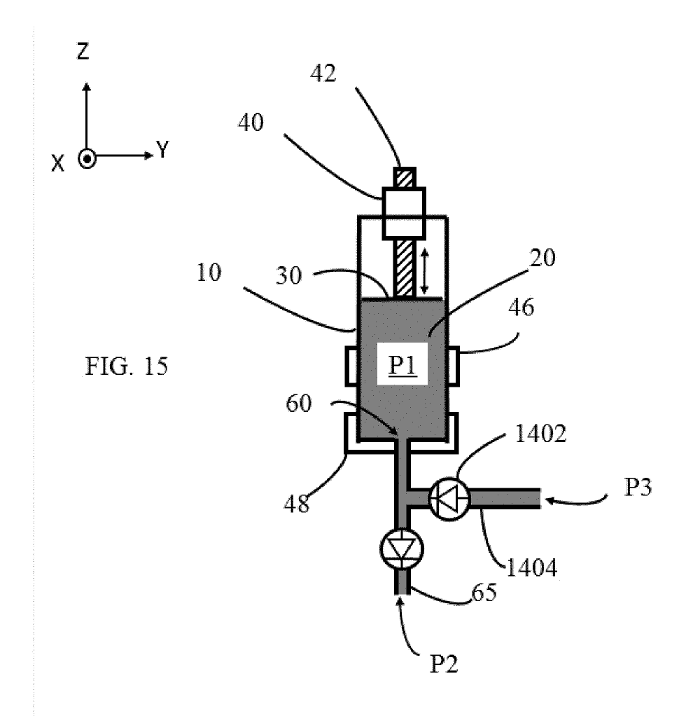

FIG. 15 shows an alternative embodiment including an extruder with two one-way valves. The one-way valves are attached between the opening of the chamber 10 and the nozzle 65 opening. The operation of the valves is substantially the same as previously described.

In some embodiments two or more chambers are used and each chamber feeds the material to be extruded through an opening in each chamber, to the nozzle inlets. Therefore, between the outlet of the chambers and the nozzle inlets the two materials combined prior to being extruded through the nozzle. The location or region where the combination occurs is an in-line mixer. For example, with two chambers, the mixer can be in a “Y”-shaped configuration wherein the mixing chamber has two inlets connected to the outlets of the chambers and one outlet connected to the nozzle inlet. The size of the inlets to the chamber can be each of different sizes, for example to control the amount of material from each chamber allowed into the mixing chamber. The chamber can be an elongated tube, elliptical, rectangular, conical or any other suitable shape. Mechanical mixing such as rotating propellers, paddles, rotor stators and/or turbines can be used to improve the mixing. Mechanical stationary means such as a static mixer can also be used. In some embodiments, a static in-line mixer is used. In other embodiments two or more chambers with each having a corresponding outlet and nozzle can be utilized, for example, such as to produce non-contacting portions faster due to the possible parallel processing of material. In another embodiment, the chamber can have two or more openings and/or nozzles for extruding material.

The materials that can be partitioned using the apparatus described herein include liquids with low medium and high viscosity. In some embodiments the materials have medium to low viscosities at room temperature. In embodiments wherein the materials have a medium viscosity at room temperature, the materials can optionally be headed to lower the viscosity (e.g., between about 40 and about 100 degrees Celsius, between about 40 and 80 degrees Celsius).

In some optional embodiments the receptacle is not partitionable but the material can be easily removed from or detached from the receptacle. For example, the receptacle can be one or more molds. For example, the mold can include an array of 2 or more shapes, each of which can be filled with material to make a non-contacting portion (e.g., an array of 2, 3 or 4 shapes makes 2, 3 or 4 non-contacting portions respectively). Alternatively, an array of molds can be placed on the stage for example each mold having one or more shapes. The mold can also be shaped from any suitable material such as plastics, silicones and cellulosic materials. The mold can even be stamped into an appropriate powdered material such as corn starch. A releasing agent can be applied to the mold such as cornstarch and/or the surface disposed for contacting the material has a low surface energy such below about 40 mN/m (e.g., below about 30 mN/m).

The embodiments include using materials that include cannabis extracts. There has been a growing interest and public acceptance of the use of cannabis for medicinal and recreational use. The plant material has been used for their therapeutic effects in treating the symptoms of cancer, aids, multiple sclerosis, pain, glaucoma, epilepsy and other conditions. In the plant, some of the active components include cannabigerolic acid (CBGA), cannabichromene acid (CBCA), cannabidiol acid (CBDA), Δ⁹-tetrahydrocannabinolic acid (THCA) and cannabinol acid (CBNA). These can be used in creams, eye drops, therapeutic patches, edible pills and by heating the material and inhaling the smoke such as through a cannabis cigarette or pipe. Heating cannabinoids decarboxylates the components described above producing cannabigerol (CBG), cannabichromene (CBC), cannabidiol (CBD), Δ⁹-tetrahydrocannabinol (THC) and cannabinol (CBN) and volatilizes the components. In addition to the above, cannabis extracts also include many other ingredients such as terpenes. For example; Pinene (e.g., alpha-Pinene, Beta-Pinene), Myrcene, Limonene, Caryophyllene, Linalool, Terpinolene, Camphene, Phellandrene, Humulene, Phellandrene, Phytol, Pulegone, Bergamotene, Farnesene, Delta-3-Carene, Elemene, Fenchol, Aromadendrene, Bisabolene, alpha-Bisabolol, Borneol, Eucalyptol, Cineole and mixtures of these. In addition to smell and taste, these auxiliary components purportedly can provide synergistic medicinal properties. Excessive and/or prolonged heating of these terpenes can volatilize them removing them from the extract which can be detrimental to the efficacy of the extract.

The above extracts can be combined with other ingredients such as sugar, starch, oils, fats (e.g., vegetable fats) and jelly prior to portioning. In some embodiments, the materials are not heated above about 120 degrees Celsius while being extruded. For example, the material can be extruded at temperatures between about room temperature and 100 degrees Celsius (e.g., between about 40 and about 100 degrees Celsius, between about 40 and 80 degrees Celsius). In addition, in some embodiments the material is not heated for prolonged periods of time, such as for less than about 30 min (e.g., less than about 20 minutes, less than about 10 minutes). Control of the temperature can avoid the decomposition and/or volatilization of terpenes. For example, using a multi-zone temperature controller a chamber can be heated to a first temperature that avoids decomposition of terpenes but allow flow of material, and a nozzle can be heated to a higher temperature to provide better flow of the material and limited exposure of the material to the higher temperature. It is understood that, since the chamber/syringe holding materials is a closed system, loss of volatile materials is expected to be minimal until the material is extruded.

In some other embodiments, temperatures above about 110 degrees Celsius may be desired. For example, temperatures above 110 degrees can be utilized if decarboxylation of THC is desired.

Embodiments of the various aspects described herein can be illustrated by the following numbered paragraphs.

1. A method of partitioning a material, the method comprising;
extruding said material from a chamber and through a CNC controlled nozzle and arraying said material onto a partitionable receptacle forming an array of non-contacting portions.
   2. The method according to paragraph 1, wherein the partitionable receptacle has a surface for arraying said material upon with a surface energy below about 40 mN/m.
   3. The method according to paragraph 1 or 2, wherein the partitionable receptacle comprises a container (e.g., a capsule such as a medicinal, herbal or drug capsule, a vaporizing pen cartridge, a jar for a cream or for holding wax or oil).
   4. The method according to any one of paragraphs 1-3, wherein the partitionable receptacle comprises a coupon. (e.g., metal, plastic, paper, transdermal patch).
   5. The method according to any one of paragraphs 1-4, wherein the partitionable receptacle is a component of a transdermal patch.
   6. The method according to any one of paragraphs 1-5, wherein the material comprises a cannabis extract.
   7. The method according to paragraph 6, wherein the cannabis extract is selected from the group consisting of cannabigerolic acid (CBGA), cannabichromene acid (CBCA), cannabidiol acid (CBDA), Δ⁹-tetrahydrocannabinolic acid (THCA), cannabinol acid (CBNA). cannabigerol (CBG), cannabichromene (CBC), cannabidiol (CBD), Δ⁹-tetrahydrocannabinol (THC), cannabinol (CBN) and combinations thereof.
   8. The method according to any one of paragraphs 1-7, wherein the material comprises a terpene.
   9. The method according to any one of paragraphs 1-8, wherein the terpene is selected from the group consisting of Pinene (e.g., alpha-Pinene, beta-Pinene), Myrcene, Limonene, Caryophyllene, Linalool, Terpinolene, Camphene, Phellandrene, Humulene, Phellandrene, Phytol, Pulegone, Bergamotene, Farnesene, Delta-3-Carene, Elemene, Fenchol, Aromadendrene, Bisabolene, alpha-Bisabolol, Borneol, Eucalyptol, Cineole and combinations thereof.
   10. The method according to any one of paragraphs 1-9, wherein each portion comprises between about 1 mg and 100 g (e.g., between about 1 mg and 1 g, between about 1 mg and 500 mg of material, between about 1 mg and about 200 mg, between about 10 and about 100 mg) of material.
   11. The method according to any one of paragraphs 1-10, wherein the standard deviation of the average of the masses of the array of non-contacting portions is less than about 10%.
   12. The method according to any one of paragraphs 1-11, wherein the portions are deposited at a rate of between about 1 mg/s and about 1000 mg/s.
   13. The method according to any one of paragraphs 1-12, wherein the method is a batch process.
   14. The method according to any one of paragraphs 1-13, wherein the array comprises between 2 and 5000 portions.
   15. The method according to any one of paragraphs 1-14, further comprising a second CNC controlled nozzle for arraying said material.
   16. The method according to any one of paragraphs 1-15, wherein the portions are consumable by ingestion, by inhalation, by smoking, sublingually or transdermally.
   17. The method according to any one of paragraphs 1-16, wherein the portions are produced at a rate of between about 0.002 and about 10 portions per second.
   18. The method according to any one of paragraphs 1-17, wherein the material is heated and has a temperature between about 40 and about 100 degrees Celsius (e.g., between about 40 and 80 degrees Celsius) while being extruded.
   19. The method according to any one of paragraphs 1-18, wherein the material is heated using a multi-zone heater having a first and a second zone.
   20. The method according to paragraph 19, wherein the difference in temperature between a first zone and second zone of the multi-zone heater is at least about 5 degrees Celsius.
   21. The method according to paragraphs 19 or 20 wherein the difference in temperature between the first and second zone of the multi-zone heater is less than about 80 degrees Celsius.
   22. The method according to any one of paragraphs 19 through 21, wherein the temperature of the first and the second zone is less than about 110 degrees Celsius (e.g., less than about 100 degrees Celsius, less than about 90 degrees Celsius, less than about 80 degrees Celsius)
   23. The method according to any one of paragraphs 1-22, wherein the material has a viscosity below about 1,000,000 centipoise (e.g., below about 10,000 centipoise) while being extruded, and/or the material has a viscosity above about 10,000 centipoise.
   24. The method of any one of paragraphs 1-23, wherein the portions have an average width to average height ratio of greater than about two (e.g. between about 2 and about 100).
   25. The method according to any one of paragraphs 1-24, wherein the material is made to contact and pass through, on and/or across a flexible applicator after being extruded and prior to being deposited onto the partitionable receptacle.
   26. The method according to paragraph 25, wherein the flexible applicator is selected from the group consisting of a plastic nozzle, a silicone nozzle and a plastic tube.
   27. The method according to any one of paragraphs 1-26, further comprising extruding material from the chamber through a one-way valve and through the nozzle.
   28. The method according to any one of paragraphs 1-27, further comprising filling the chamber with material through a one-way valve attached to a reservoir of the material.
   29. A method of partitioning a material, the method comprising;
extruding said material through a CNC controlled nozzle and arraying said material into
at least two molds forming an array of non-contacting portions.
   30. A 3D printer for partitioning a material, the printer comprising;
a. a chamber capable of containing the material, the chamber including at least one movable wall
b. a mechanism for moving the wall, the mechanism being CNC controlled,
c. a multi-zone heater configured for heating the chamber, comprising at least a first and a second heater,
d. an opening in the chamber through which the material can be extruded to produce extruded material,
e. a stage for receiving the extruded material from the opening, wherein the relative positioning of the stage and opening is CNC controlled.
   31. The 3D printer according to paragraph 30, wherein the chamber is configured as a syringe, the movable wall is configured as a plunger coupled to the syringe and the first heater is configured to couple with the syringe barrel in a removable fashion.
   32. The 3D printer according to paragraph 31, wherein the first heater is configured to couple with the syringe in a removable fashion by utilizing an adaptor configured as a body having outer dimensions commensurate with the first heater and a hole through the body having a diameter equal to or larger than the syringe outer diameter.
   33. The 3D printer according to paragraph 32, wherein the adaptor comprises a metal.
   34. The 3D printer as in any one of paragraphs 31 through 33, wherein the syringe has a cylindrical barrel.
   35. The 3D printer according to any one of paragraphs 31 through 34, wherein the force required to move the syringe in the direction of movement of the plunger is greater than the force required to move the syringe in a direction perpendicular to the direction of movement of the plunger.
   36. The 3D printer according to paragraph 35, wherein the difference in force required to move the syringe in the direction of movement of the plunger and a direction perpendicular to the movement of the plunger is at least 10 Newton.
   37. The 3D printer according to any one of paragraphs 30 through 36, further comprising a nozzle in fluid communication with the chamber and wherein the second heater is configured to couple with the nozzle (e.g., the nozzle and heater have complementary threading).
   38. The 3D printer according to any one of paragraphs 30 through 37, wherein the first and second heater can provide a temperature difference of at least 5 degrees Celsius.
   39. The 3D printer according to any one of paragraphs 30 through 37, wherein the first and second heater can provide a difference in temperature of less than about 80 degrees Celsius.
   40. The 3D printer according to any one of paragraphs 30 through 39, wherein the first and second heater can provide a temperature that is less than about 110 degrees Celsius (e.g., less than about 100 degrees Celsius, less than about 90 degrees Celsius, less than about 80 degrees Celsius)
   41. The 3D printer according to any one of paragraphs 30 through 40, wherein the first heater comprises a flexible silicone heater and the second heater comprises a cartridge.
   42. The 3D printer according to any one of paragraphs 30 through 41, wherein the first heater comprises an enclosure containing the chamber.
   43. The 3D printer according to paragraph 42, wherein the enclosure comprises at least a portion that is transparent.
   44. The 3D printer according to any one of paragraphs 30 through 43, further comprising and inlet to the chamber, a reservoir and a first one-way valve disposed therebetween, wherein the one-way valve provides fluid communication between the chamber and reservoir with a direction of flow from the reservoir to the chamber.
   45. The 3D printer according to paragraph 44, further comprising a second one-way valve disposed between chamber and the opening (e.g. outlet to the chamber), wherein the one-way valve provides fluid communication between the chamber and outside of the chamber with a direction of flow from the chamber to outside of the chamber.
   46. The 3D printer according to paragraph 45, further comprising a nozzle in fluid communication with the outlet and the first and second one-way valve, wherein the first one-way valve allows flow of material from the reservoir, through the outlet and through the nozzle, and the second one-way valve allows flow of material from a reservoir to the outlet and into the chamber.
   47. A 3D printer for partitioning a material, the printer comprising;
a. a chamber capable of containing the material, the chamber including at least one movable wall
b. a mechanism for moving the wall, the mechanism being CNC controlled,
c. an opening in the chamber through which the material can be extruded to produce extruded material,
d. a first one-way valve disposed between chamber and the opening (e.g., outlet)
e. a stage for receiving the extruded material from the opening, wherein the relative positioning of the stage and opening is CNC controlled
   wherein the one-way valve provides fluid communication between the chamber and outside of the chamber with a direction of flow from the chamber to outside of the chamber.
      48. The 3D printer according to paragraph 47, further comprising an inlet to the chamber, a reservoir and a second one-way valve disposed therebetween, wherein the one-way valve provides fluid communication between the chamber and reservoir with a direction of flow from the reservoir to the chamber.
      49. The 3D printer according to paragraph 48, further comprising a nozzle in fluid communication with the opening and the first and second one-way valve, wherein the first one-way valve allows flow of material from the chamber, through the opening and through the nozzle, and the second one-way valve allows flow of material from the reservoir to the opening and into the chamber.
      50. A method of partitioning material, the method comprising;
extruding said material from a chamber and through a CNC controlled first one-way nozzle, and arraying said material onto a partitionable receptacle forming an array of non-contacting portions.
   51. The method according to paragraph 50, further comprising filling the chamber from a reservoir through a second one-way valve in fluid communication with an opening to the chamber.
   52. The method according to paragraph 51, wherein during the filling step, the first one-way valve is shut.
   53. The method according to paragraph 51, wherein during extruding said material, the second one-way valve is shut.
   54. A method of partitioning a material, the method comprising;
   extruding said material from a chamber and through a CNC controlled nozzle and arraying said material into at least two molds forming an array of non-contacting portions, wherein the material is heated using a multi-zone heater having a first and a second zone.
   55. The method according to paragraph 54, wherein the material is extruded through at least one one-way valve (e.g., at least 2 one-way valves).

### EXEMPLIFICATION

### Example 1

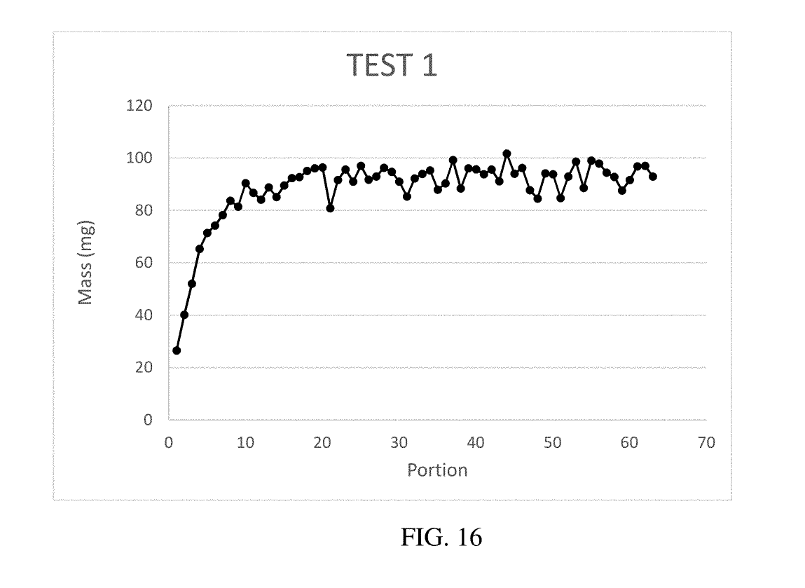

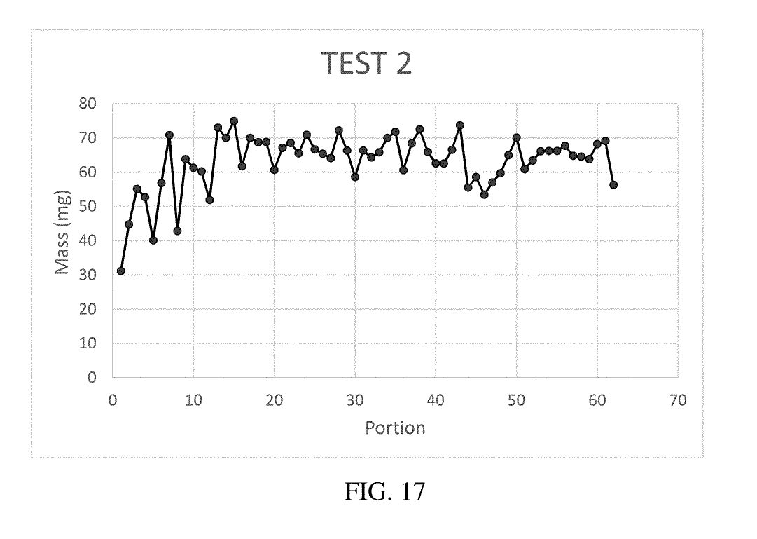

An extruder such as described by FIG. 6 and having a chamber volume of about 60 mL was attached to a CNC mill having a bed size of 30×50 cm. The extruder was attached to the Z axis of the CNC mill in place of the drilling tool. An Arduino 2560 board was electrically attached to the stepper motors of the Z, X, Y and Extruder. A Marlin open source code was used to flash the board and Simplify 3D (Ver. 3.0.2) slicer program was used to prepare the g-code for a 9×7 array of 63 cylinders each having a diameter of 5 mm and 1 mm height. The extruder was loaded with caramel (Kraft™ Caramels). The block heater 640 was set to 100 degree Celsius and caramel was extruded onto wax paper. The heating tape 685 was not utilized. Two tests were conducted using different extrusion rates. A plot of the weight to portion is shown for each test as FIG. 16 and FIG. 17. After discarding outliers (first 9 portions deposited) the first test gave an average weight per portion of 92 mg with a standard deviation of 4 mg and a range of 21 mg; while the second test gave and average portion of 65 mg with a standard deviation of 5 mg and a range of 23 mg.

### Example 2

An extruder and multi-zone heater assembly as described by FIGS. 10A and 10B having a chamber volume of about 60 mL was attached to a CNC mill as described above. An array of the bottoms of 24 “00” size capsules was loaded into a capsule holder as described by http://capsuleconnection.com/capsule-machine/ (accessed Aug. 3, 2016). The chamber was charged with coconut oil. The heaters were set to 50 degree Celsius and a g-code program was written and executed by the Arduino board to fill the 24 capsule bottoms. After filling the capsule bottoms the tops were set in place and the capsules weights were measured. The capsules contained and average mass of 0.54 g coconut oil, with a standard deviation of 0.01 g and a range in the data of 0.07 g.

In a comparative experiment, only the heater closest to the nozzle was utilized. The coconut oil used at room temperature was a waxy solid. Although material did extrude from the nozzle when the temperature was set at 50 degrees C., the extrusion was irregular due to intermittent blocking due to solid material temporarily blocking the nozzle before melting.

### Example 3

A 3D printer as described in Example 2 was used to fill and array of 10 silicone containers have each a volume of 5 mL and being cylindrical in shape. The array was set in an acrylic tray having holes cut therein commensurate with the containers. The extruder was charged with caramel (Kraft™ Caramels) diluted with water to reduce the viscosity. The extruder heaters were set to 70 degrees Celsius. Three different weights were targeted for each set of 10 containers. The results are shown in the Table.

TABLE
Run of 10 containers filled with Caramel

| | Mass | Std. |
|---|---|---|
| Run # | (g) | Dev. |
| 1 | 0.45 | 0.04 |
| 2 | 1.01 | 0.06 |
| 3 | 0.79 | 0.07 |

In a comparative experiment, only the heater closest to the extruder nozzle was utilized. It was found that material did not extrude out easily when this was set at 70 degrees. In some tests the extruder cracked due to high pressures required. In other tests, the temperature was raised (e.g., ˜110 degrees C.) and some extrusion occurred but the material was discolored, indicating temperature induced decomposition of the material.

Other than in the examples herein, or unless otherwise expressly specified, all of the numerical ranges, amounts, values and percentages, such as those for amounts of materials, elemental contents, times and temperatures of reaction, ratios of amounts, and others, in the following portion of the specification and attached claims may be read as if prefaced by the word “about” even though the term “about” may not expressly appear with the value, amount, or range. Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains error necessarily resulting from the standard deviation found in its underlying respective testing measurements. Furthermore, when numerical ranges are set forth herein, these ranges are inclusive of the recited range end points (e.g., end points may be used). When percentages by weight are used herein, the numerical values reported are relative to the total weight.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. The terms “one,” “a,” or “an” as used herein are intended to include “at least one” or “one or more,” unless otherwise indicated. Similarly, the word “or” is intended to include “and” unless context clearly indicates otherwise.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

While this invention has been particularly shown and described with references to optional embodiments thereof, it will be understood by those skilled in the art that various changes in form and details may be made therein without departing from the scope of the invention encompassed by the appended claims.

What is claimed is:

1. A method of partitioning a material, the method comprising;
extruding said material from a chamber and through a CNC controlled nozzle and arraying said material onto a partitionable receptacle forming an array of non-contacting portions, wherein the material is heated using a multi-zone heater having a first and a second zone.

2. The method according to claim 1, wherein the difference in temperature between a first zone and second zone of the multi-zone heater is less than about 80 degrees Celsius.

3. The method according to claim 1, wherein the temperature of the first and the second zone is less than about 110 degrees Celsius.

4. The method according to claim 1, wherein the material has a viscosity below about 1,000,000 centipoise while being extruded.

5. The method according to claim 1, wherein the material has a viscosity of greater than about 10,000 centipoise while being extruded.

6. The method according to claim 1, further comprising extruding material from the chamber through a one-way valve and through the nozzle.

7. The method according to claim 1, further comprising filling the chamber with material through a one-way valve attached to a reservoir of the material.

8. A 3D printer for partitioning a material, the printer comprising;
a. a chamber capable of containing the material, the chamber including at least one movable wall
b. a mechanism for moving the wall, the mechanism being CNC controlled,
c. a multi-zone heater configured for heating the chamber, comprising at least a first and a second heater,
d. an opening in the chamber through which the material can be extruded to produce extruded material,
e. a stage for receiving the extruded material from the opening, wherein the relative positioning of the stage and opening is CNC controlled.

9. The 3D printer according to claim 8, wherein the chamber is configured as a syringe, the movable wall is configured as a plunger coupled to the syringe and the first heater is configured to couple with the syringe barrel in a removable fashion.

10. The 3D printer according to claim 8, wherein the first heater is configured to couple with the syringe in a removable fashion by utilizing an adaptor configured as a body having outer dimensions commensurate with the first heater and a hole through the body having a diameter equal to or larger than the syringe outer diameter.

11. The 3D printer according to claim 8, wherein the force required to move the syringe in the direction of movement of the plunger is greater than the force required to move the syringe in a direction perpendicular to the direction of movement of the plunger.

12. The 3D printer according to claim 8, further comprising a nozzle in fluid communication with the chamber and wherein the second heater is configured to couple with the nozzle.

13. The 3D printer according to claim 8, wherein the first heater comprises a flexible silicone heater and the second heater comprises a cartridge heater.

14. The 3D printer according to claim 8, wherein the first heater comprises an enclosure containing the chamber.

15. The 3D printer according to claim 14, wherein the enclosure comprises at least a portion that is transparent.

16. The 3D printer according to claim 8, further comprising and inlet to the chamber, a reservoir and a first one-way valve disposed therebetween, wherein the one-way valve provides fluid communication between the chamber and reservoir with a direction of flow from the reservoir to the chamber.

17. The 3D printer according to claim 16, further comprising a second one-way valve disposed between chamber and the opening, wherein the one-way valve provides fluid communication between the chamber and outside of the chamber with a direction of flow from the chamber to outside of the chamber.

18. The 3D printer according to claim 17, further comprising a nozzle in fluid communication with the outlet and the first and second one-way valve, wherein the first one-way valve allows flow of material from the reservoir, through the outlet and through the nozzle, and the second one-way valve allows flow of material from a reservoir to the outlet and into the chamber.

19. A method of partitioning a material, the method comprising;
extruding said material from a chamber and through a CNC controlled nozzle and arraying said material into at least two molds forming an array of non-contacting portions, wherein the material is heated using a multi-zone heater having a first and a second zone.

20. The method of claim 19, wherein the material is extruded through at least one one-way valve.
